(19) United States
(12) Patent Application Publication
(10) Pub. No.: US 2024/0154288 A1
(43) Pub. Date: May 9, 2024

(54) ANGLED COAXIAL CABLE ADAPTER STRUCTURALLY CONFIGURED TO PROVIDE AN ENHANCED RADIO FREQUENCY (RF) SIGNAL

(71) Applicant: PPC BROADBAND, INC., East Syracuse, NY (US)

(72) Inventors: Daniel DAOUST, Syracuse, NY (US); Jordan CAVINESS, Liverpool, NY (US)

(73) Assignee: PPC BROADBAND, INC., East Syracuse, NY (US)

(21) Appl. No.: 18/387,400

(22) Filed: Nov. 6, 2023

Related U.S. Application Data
(60) Provisional application No. 63/423,044, filed on Nov. 6, 2022.

(51) Int. Cl. H01P 3/06; H01P 1/02

(52) U.S. Cl. CPC H01P 3/06; H01P 1/022

(57) ABSTRACT

An angled coaxial cable adapter may include a housing portion structurally configured to include a first RF signal wave receiving portion and a second RF signal wave receiving portion and a conductive portion structurally configured to pass an RF signal through the first RF signal wave receiving portion and the second RF signal wave receiving portion. The first RF signal wave receiving portion may be configured to be disposed at an angle relative to the second RF signal wave receiving portion, and the conductive portion may be structurally configured to include a bend. The RF signal wave blocking portion may be structurally configured to block the first RF signal wave and the second RF signal wave from interfering with one another so as to reduce potential noise when a signal changes direction at the bend of the conductive element such that the adapter can provide an enhanced RF signal.

### CROSS-REFERENCE TO RELATED APPLICATION

This application claims the benefit of U.S. Provisional Application No. 63/423,044 filed Nov. 6, 2022, the disclosure of which is hereby incorporated by reference herein in its entirety.

### TECHNICAL FIELD

The present disclosure generally relates in general to electrical connectors or adapters for coaxial cables, and more particularly, to an angled connector or adapter for receiving at least one coaxial cable.

### BACKGROUND

In transmitting a signal through a central conductor of a coaxial cable, it is generally preferred to have noise-free transmission. More specifically, it is desired to minimize radio frequency (RF) interference and noise levels. However, routing of coaxial cables often requires the cables to be arranged perpendicularly or at other angles to the connection ports or printed circuit boards they serve. In general, the cables lack the flexibility needed to make sharp bends at the locations of these ports and boards. Therefore, rather than bending the cables, terminals for connecting the cables to the connection ports and printed circuit boards are typically bent to provide the needed turn.

It is common practice to utilize a soldered joint for terminating cable center conductors to the bent terminal, or to provide a right angle connection. Soldered joints are typically more expensive and time consuming than the simpler crimp connections, and usually must be done after the wire end and terminal are placed in the connector. However, both soldered and crimped joints reduce the RF performance of the connection. Significant geometry variations in the signal path caused by the bend area of the terminal instigate further interference and noise.

In standard coaxial cable connectors/adapters, internal cavities or chambers are formed around the angled joint and around the bend in the conductive element (pin or insert). These chambers of different directions often provide sharp corners or bends that create interference in the signal passing through the connector/adapter and considerably reduce the RF performance of the connection. Accordingly, there is a need for an angled coupling element such as an adapter or connector that improves RF performance by minimizing potential interference in the signal as the signal changes direction in the angled coupling element.

For example, it may be desirable to provide an angled coaxial adapter that is structurally configured to prevent interference between a first signal wave and a second signal wave so as to reduce potential noise and potential interference between the first signal wave and the second signal wave when a signal changes direction at a bend of the angled coaxial coupler enhance signal quality of the adapter so as to provide an enhanced RF signal, including at frequencies of 1.3 GHz and greater.

### SUMMARY

According to various exemplary embodiments of the disclosure, an angled coaxial cable adapter may include a housing portion structurally configured to include a first RF signal wave receiving portion, a second RF signal wave receiving portion, and a third RF signal wave receiving portion disposed between the first RF signal wave receiving portion and the second RF signal wave receiving portion. A conductive portion may be structurally configured to pass an RF signal through the first RF signal wave receiving portion, the second RF signal wave receiving portion, and the third RF signal wave receiving portion of the housing. A first insulating portion may be structurally configured to hold a first portion of the conductive element in the first RF signal wave receiving portion of the housing, and a second insulating portion may be structurally configured to hold a second portion of the conductive element in the second RF signal wave receiving portion of the housing. An RF signal wave blocking portion may be structurally configured to block an RF signal wave in the first RF signal wave receiving portion of the housing or an RF signal wave in the second RF signal wave receiving portion of the housing from entering the third RF signal wave receiving portion of the housing. The first RF signal wave receiving portion may be structurally configured to be disposed at an angle relative to the second RF signal wave receiving portion, the conductive portion may be structurally configured to include a bend at the third RF signal wave receiving portion of the housing, and the conductive portion may include a first conductive portion at least partially disposed in the first RF signal wave receiving portion of the housing and a second conductive portion at least partially disposed in the second RF signal wave receiving portion of the housing. The RF signal wave blocking portion may include a first RF signal wave blocking portion between the first RF signal wave receiving portion and the third RF receiving portion that is structurally configured to block a first RF signal wave in the first RF signal wave receiving portion from entering the third RF signal wave receiving portion and a second RF signal wave blocking portion between the second RF signal wave receiving portion and the third RF receiving portion that is structurally configured to block a second RF signal wave in the second RF signal wave receiving portion from entering the third RF signal wave receiving portion. The first RF signal wave blocking portion and the second RF signal wave blocking portion may be structurally configured to block the first RF signal wave and the second RF signal wave from interfering with one another so as to reduce potential noise when a signal changes direction at the bend of the conductive element such that the adapter can provide an enhanced RF signal at frequencies of 1.3 GHz and greater.

In accordance with various exemplary embodiments of the disclosure, an angled coaxial cable adapter may include a housing portion structurally configured to include a first RF signal wave receiving portion and a second RF signal wave receiving portion, a conductive portion structurally configured to pass an RF signal through the first RF signal wave receiving portion, the second RF signal wave receiving portion, and the third RF signal wave receiving portion of the housing, and an RF signal wave blocking portion structurally configured to block an RF signal wave in the first RF signal wave receiving portion of the housing or an RF signal wave in the second RF signal wave receiving portion of the housing from entering the third RF signal wave receiving portion of the housing. The first RF signal wave receiving portion may be structurally configured to be disposed at an angle relative to the second RF signal wave receiving portion, and the conductive portion may be structurally configured to include a bend at the third RF signal wave receiving portion of the housing. The RF signal wave blocking portion may be structurally configured to block the first RF signal wave and the second RF signal wave from interfering with one another so as to reduce potential noise when a signal changes direction at the bend of the conductive element such that the adapter can provide an enhanced RF signal at frequencies of 1.3 GHz and greater.

According to various exemplary embodiments of the disclosure, an angled coaxial cable adapter may include a housing portion structurally configured to include a first RF signal wave receiving portion and a second RF signal wave receiving portion and a conductive portion structurally configured to pass an RF signal through the first RF signal wave receiving portion and the second RF signal wave receiving portion. The first RF signal wave receiving portion may be configured to be disposed at an angle relative to the second RF signal wave receiving portion, and the conductive portion may be structurally configured to include a bend. The RF signal wave blocking portion may be structurally configured to block the first RF signal wave and the second RF signal wave from interfering with one another so as to reduce potential noise when a signal changes direction at the bend of the conductive element such that the adapter can provide an enhanced RF signal.

In some aspects of the foregoing embodiments, the angled coaxial cable adapter may further include a first insulating portion structurally configured to hold a first portion of the conductive element in the first RF signal wave receiving portion of the housing and a second insulating portion structurally configured to hold a second portion of the conductive element in the second RF signal wave receiving portion of the housing.

In some aspects of one or more of the foregoing embodiments, the conductive portion may include a first conductive portion at least partially disposed in the first RF signal wave receiving portion of the housing and a second conductive portion at least partially disposed in the second RF signal wave receiving portion of the housing.

In some aspects of one or more of the foregoing embodiments, the angled coaxial cable adapter may further comprise a third RF signal wave receiving portion disposed between the first RF signal wave receiving portion and the second RF signal wave receiving portion.

In some aspects of one or more of the foregoing embodiments, the RF signal wave blocking portion may include a first RF signal wave blocking portion between the first RF signal wave receiving portion and the third RF receiving portion that is structurally configured to block a first RF signal wave in the first RF signal wave receiving portion from entering the third RF signal wave receiving portion and a second RF signal wave blocking portion between the second RF signal wave receiving portion and the third RF receiving portion that is structurally configured to block a second RF signal wave in the second RF signal wave receiving portion from entering the third RF signal wave receiving portion.

In some aspects of one or more of the foregoing embodiments, the first RF signal wave blocking portion and the second RF signal wave blocking portion each may include a conductive material.

In some aspects of one or more of the foregoing embodiments, the first RF signal wave receiving portion may be structurally configured to be disposed at a ninety degree angle relative to the second RF signal wave receiving portion.

In some aspects of one or more of the foregoing embodiments, the housing portion may include a first portion that is structurally configured to define the first RF signal wave receiving portion and a second portion that is structurally configured to define the second RF signal wave receiving portion.

In some aspects of one or more of the foregoing embodiments, a first portion of the housing portion may be structurally configured to be electrically coupled with an interface port and a second portion of the housing portion is structurally configured to be electrically coupled with a coaxial cable connector.

In some aspects of one or more of the foregoing embodiments, the RF signal wave blocking portion may comprise a conductive material.

In some aspects of one or more of the foregoing embodiments, wherein the RF signal wave blocking portion may be structurally configured to block the first RF signal wave and the second RF signal wave from interfering with one another so as to reduce potential noise when a signal changes direction at the bend of the conductive element such that the adapter can provide an enhanced RF signal at frequencies of 3 GHz and greater.

In some aspects of one or more of the foregoing embodiments, the RF signal wave blocking portion may be structurally configured to block the first RF signal wave and the second RF signal wave from interfering with one another so as to reduce potential noise when a signal changes direction at the bend of the conductive element such that the adapter can provide an enhanced RF signal at frequencies of 1.3 GHz and greater.

### BRIEF DESCRIPTION OF THE DRAWINGS

Further advantages and features of the present disclosure will become apparent from the following description and the accompanying drawings, to which reference is made. In which are shown:

FIG. 1 is a cross-sectional perspective view of a conventional coaxial cable adapter.

FIG. 2 is a cross-sectional perspective view of a conventional coaxial cable connector.

FIG. 3 is a cross-sectional perspective view of an exemplary coaxial cable adapter according to various aspects of the present disclosure.

FIG. 4 is a cross-sectional perspective view of another exemplary coaxial cable adapter according to various aspects of the present disclosure.

FIG. 5 is a cross-sectional perspective view of yet another exemplary coaxial adapter according to various aspects of the present disclosure.

FIG. 6 is a cross-sectional side view of yet another exemplary coaxial adapter according to various aspects of the present disclosure.

### DETAILED DESCRIPTION

Reference will now be made in detail to presently preferred embodiments and methods of the present disclosure, which constitute the best modes of practicing the present disclosure presently known to the inventors. The figures are not necessarily to scale. However, it is to be understood that the disclosed embodiments are merely exemplary of the present disclosure that may be embodied in various and alternative forms. Therefore, specific details disclosed herein are not to be interpreted as limiting, but merely as a representative basis for any aspect of the present disclosure and/or as a representative basis for teaching one skilled in the art to variously employ the present disclosure.

It is also to be understood that this present disclosure is not limited to the specific embodiments and methods described below, as specific components and/or conditions may, of course, vary. Furthermore, the terminology used herein is used only for the purpose of describing particular embodiments of the present disclosure and is not intended to be limiting in any way.

It must also be noted that, as used in the specification and the appended claims, the singular form “a,” “an,” and “the” comprise plural referents unless the context clearly indicates otherwise. For example, reference to a component in the singular is intended to comprise a plurality of components.

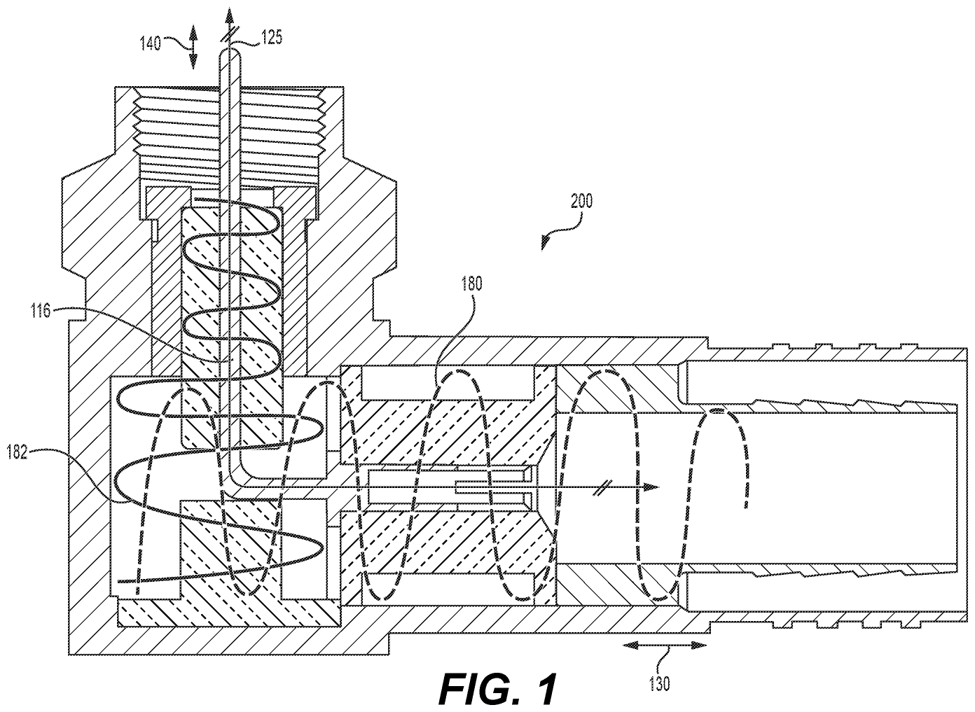

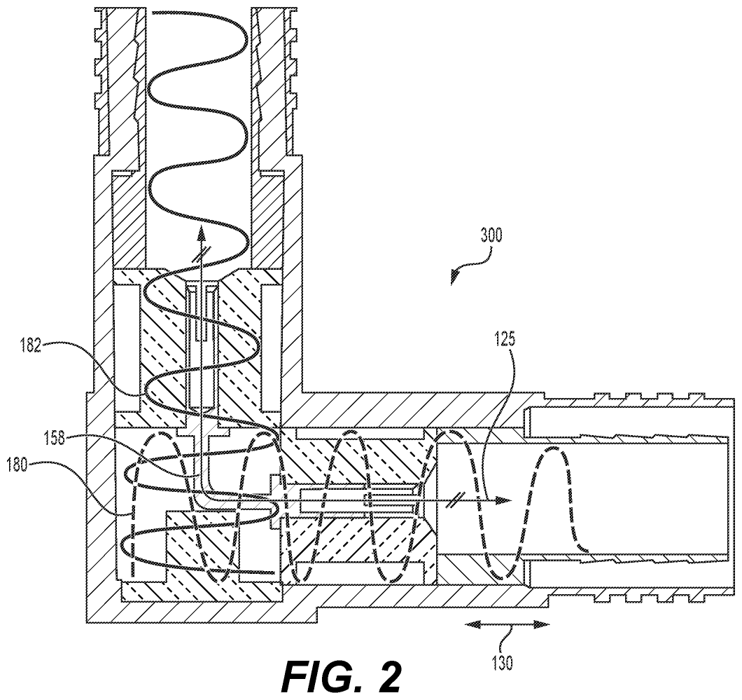

As indicated in the prior art, it is generally preferred to minimize radio frequency (RF) interference and noise levels. However, routing of coaxial cables often requires the cables to be arranged perpendicularly or at other angles to the connection ports or printed circuit boards they serve. Noting that coaxial cables lack the flexibility needed to make sharp bends at the locations of these ports and boards, coaxial adapters (FIG. 1) and coaxial connectors (FIG. 2) may include a terminal pin or conductive insert that makes a sharp bend. However, the significant change in direction could cause interference in the signal as the signal changes from a first direction to a second direction.

As shown in FIG. 1, a conventional angled coaxial cable adapter 200 includes a bent terminal pin 116 wherein radio frequency (RF) signals 125 may travel bidirectionally along a first direction 130 to a bend, for example, 90 degrees, and then in a second direction 140 and in the second direction 140 to the bend, and then in the first direction 130. The RF signals 125 generate first signal waves 180 that travel in the first direction 130 and second signal waves 182 that travel in the second direction 140. As shown in FIG. 2, the first signal waves 180 and the second signal waves 182 interfere with one other at an interior of the adapter, for example, proximate the bend, thereby resulting in noise at the adapter 200 that degrades quality of the signal 125. Although the illustrated embodiment shows a 90-degree bend, it should be understood that the angled adapter may have a bend that is greater or less than 90 degrees.

Similarly, as shown in FIG. 2, a conventional angled coaxial cable connector 300 includes a bent conductive insert 158 wherein RF signals 125 may travel along the first direction 130 to a bend, for example, 90 degrees, and then in a second direction 140 and in the second direction 140 to the bend, and then in the first direction 130. The signal 125 generates first signal waves 180 in the first direction 130 and second signal waves 182 in the second direction 140. As shown in FIG. 2, the first signal waves 180 and the second signal waves 182 interfere with one other at an interior of the adapter, thereby resulting in noise at the connector 300 that degrades quality of the signal 125.

Therefore, the present disclosure provides a coupler 10 in the form of an adapter 12, wherein the coupler provides improved performance at higher signal frequencies by preventing or reducing interference between the first signal waves and the second signal waves. In some aspects, the coupler 10 may be in the form of a connector 112.

The present disclosure provides a coupler in the form of an adapter or a connector, wherein the coupler provides improved performance, for example, at higher signal frequencies, by preventing or reducing interference between the first signal waves 80 and the second signal waves 82.

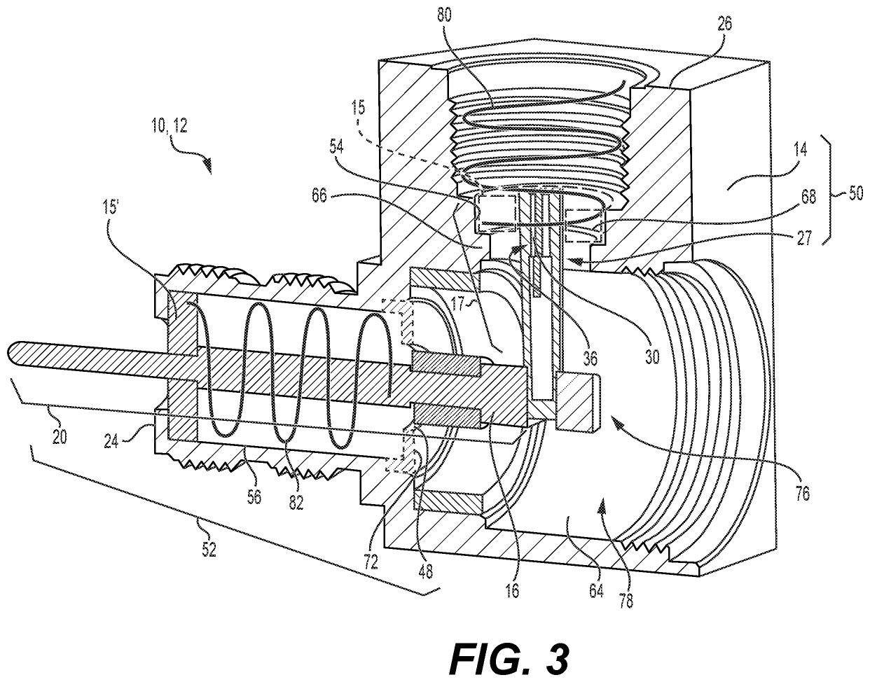

Referring to FIGS. 3-6, exemplary coaxial cable adapters 12 in accordance with the present disclosure are depicted. The coaxial cable adapter 12 is angled and is configured for use with hardline or semi-rigid coaxial cables. The angle of the coaxial cable adapter 12 may be 90 degrees as shown, or the angle may be less than or more than 90 degrees. The coaxial cable adapter 12 are configured to provide both an electrical and mechanical connection between a network device (not shown) and a coaxial cable 40. For example, the coaxial cable adapter may be structurally configured to couple a coaxial cable, for example, a hardline coaxial cable, with an interface port of a network device, for example, a tap, a splitter, an amplifier, or the like, or with another coaxial cable, for example, a hardline coaxial cable.

The angled coaxial cable adapters 12 of FIGS. 3-6 include a housing portion or housing 14, for example, a conductive housing, having a first portion or rearward end 26, for example, a cable receiving end, and a second portion or forward end 24 opposite the rearward end 26. The adapters 12 include a conductive portion 16, for example, a terminal pin. Although FIG. 3 illustrates the first portion 24 as an externally threaded male interface and the second portion 26 as an internally threaded female port, it should be understood that the configurations of the first and second portions 24, 26 may be reversed, or both may be externally threaded male interfaces, or both may be internally threaded female ports, or any other conventional configuration(s).

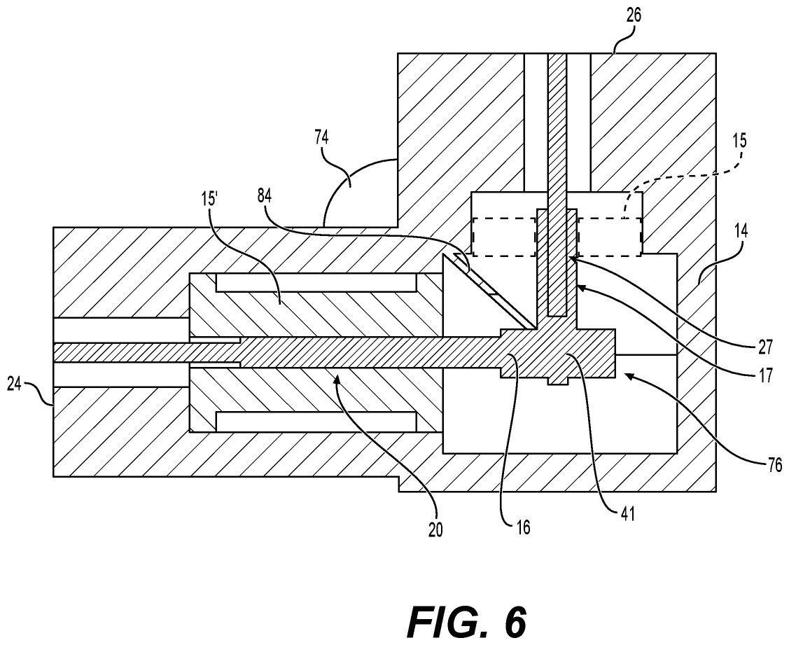

The terminal pin 16 may include a conductor receiving portion 27 at a first end of the terminal pin 16, which may be disposed at the rearward end 26 of the housing 14 and may be configured to receive a center conductor or terminal pin, for example, of a coaxial cable connector. The conductor receiving portion 27 may include a plurality of axial slots 30 extending from the first end of the terminal pin in a forward direction 32, as shown in FIG. 3, wherein the forward direction 32 is from the rearward cable receiving end 26 towards the forward end 24 such that the forward direction includes a bend 76 that defines an angle, as shown in FIGS. 3 and 6, consistent with the bend of the angled adapter 12. Thus, if the adapter 12 has a 90-degree angle, then the forward direction 32 bends or changes 90 degrees. The axial slots 30 in the terminal pin 16 may define a gripping portion 36, for example, a plurality of flexible fingers, that is structurally configured to define the conductor receiving portion 27. The gripping portion 36 may be structurally configured to extend into a first insulating portion or insulator 15 such that the first insulator 15 is structurally configured to maintain a grip of the gripping portion 36 on a conductive member, for example, a center conductor 38 or a collet pin 41 that is structurally configured to be received by the conductor receiving portion 27.

As discussed above, the first insulator 15 comprises a nonconductive material and is structurally configured to support the conductor receiving portion 27 of the terminal pin 16 in the second portion 26. The first insulator 15 is also configured to be received in a first conductive portion receiving portion 54, for example, a first bore 54, in the housing 14. Accordingly, the first insulator 15 may be disposed in the first bore 54 of the housing 14.

The adapter may include a second insulating portion 15′ disposed proximate to the forward end 24. The second insulator 15′ comprises a nonconductive material and is configured to receive and support a conductive portion 42 at a second end of the terminal pin 16, which may be disposed at the forward end 24 of the housing 14. Accordingly, the second insulator 15′ may be disposed in the second conductive portion receiving portion 56 for example, a bore of the housing 14.

Referring back to the conductor receiving portion 27 of FIGS. 3-6, the axial slots 30 of the conductor receiving portion 27 may define a gripping portion 36, for example plurality of flexible fingers, that is configured to define the conductor receiving portion 27. At least a portion of the fingers 36 may be disposed in a bore 21 of the first insulator 15. The first insulator 15 may be compressed or flex in a region 29 along the bore 21 of the first insulator 15 as the conductor receiving portion 27 radially expands when a collet pin 41 or center conductor 38 of a coaxial cable is inserted into the conductor receiving portion 27.

However, with respect to the angled coaxial cable adapter 12 of FIG. 3, the angled coaxial cable adapter includes the housing 14, the terminal pin 16, the first insulator 15, and the second insulator 15′, as described above. The adapter 12 further includes a first signal blocking portion 72, for example, a conductive inward radial wall, disposed in the second conductive portion receiving portion 56 and a second signal blocking portion 66, for example, a conductive inward radial wall disposed in the first conductive portion receiving portion 54. The first insulator 15 is configured to support the conductor receiving portion 27 of the terminal pin 16 and the second insulator 15′ is configured to support the conductive portion 42 of the terminal pin 16. Of course, it should be understood that the orientation and positioning of the terminal pin 16 may be reversed.

The exemplary adapter of FIG. 3 includes a first signal wave receiving portion 60, or cavity, defined by the first conductive portion receiving portion 54 and the second signal wave blocking portion 66, a second signal wave receiving portion 62, or cavity, defined by the second conductive portion receiving portion 56 and the first signal wave blocking portion 72, and a third signal wave receiving portion 64 between the first and second signal wave receiving portions 60, 62 and defined by the housing 14 and the first and second signal blocking portions 72, 66.

In operation, the first portion 26 of the adapter 12 may be coupled with a coaxial cable, for example, a hardline coaxial cable, and the second portion 24 of the adapter 12 may be coupled with an interface port. The conductor receiving portion 27 of the terminal pin 16 is structurally configured to receive a terminal pin or center conductor of the coaxial cable, and the conductive portion 42 of the terminal pin 16 is structurally configured to be inserted into and received by the interface portion. For example, the first portion 26 of the adapter 12 may include an internally threaded portion that is structurally configured to be threadedly coupled with an externally threaded coupler of a hardline coaxial cable, and the second portion 24 of the adapter 12 may include an externally threaded portion that is structurally configured to be threadedly coupled with an internally threaded interface of the interface port.

As a radio frequency (RF) signal passes through the adapter bidirectionally, first RF signal waves 80 travel through the first signal wave receiving portion 60 in the first direction, and second RF signal waves travel through the second signal wave receiving portion 62 in the second direction. The second signal wave blocking portion 66 is structurally configured to prevent, block, or limit the first RF signal waves 80 in the first signal receiving portion 60 from entering the third signal wave receiving portion 64. Similarly, the first signal wave blocking portion 66 is structurally configured to prevent, block, or limit the second RF signal waves 82 in the second signal receiving portion 62 from entering the third signal wave receiving portion 64.

In some aspects, the adapter 12 may include the first signal blocking portion 72 but not the second signal blocking portion 66. In other aspects, the adapter 12 may include the second signal blocking portion 66 but not the first signal blocking portion 72 In such aspects, the presence of either the first signal blocking portion 72 or the second signal blocking portion 66 may prevent, block, or limit the first RF signal waves 80 or the second RF signal waves 82 from entering the third signal wave receiving portion 64 and interfering with one another.

As a result, the adapter 12 can not only operate effectively at frequencies from 0-1.2 GHz, but the adapter 12 can operate effectively at higher frequencies, such as 1.3-3.0 GHz, or even higher frequencies, such as 3.0 GHz and greater, as compared to existing adapters that operate at frequencies from 0-1.2 GHz. This is an emerging requirement for current and future RF connectors. If cross-sections are taken perpendicular to the line of signal travel path, the cross-sections remain considerably similar around the ninety-degree bend through the cavity. The electrical signal can traverse that distance with minimum radio frequency interference. Accordingly, the first signal blocking portion 72 and the second signal blocking portion 66 minimize radio frequency interference caused by the change in direction of a signal through the conductive portion 16.

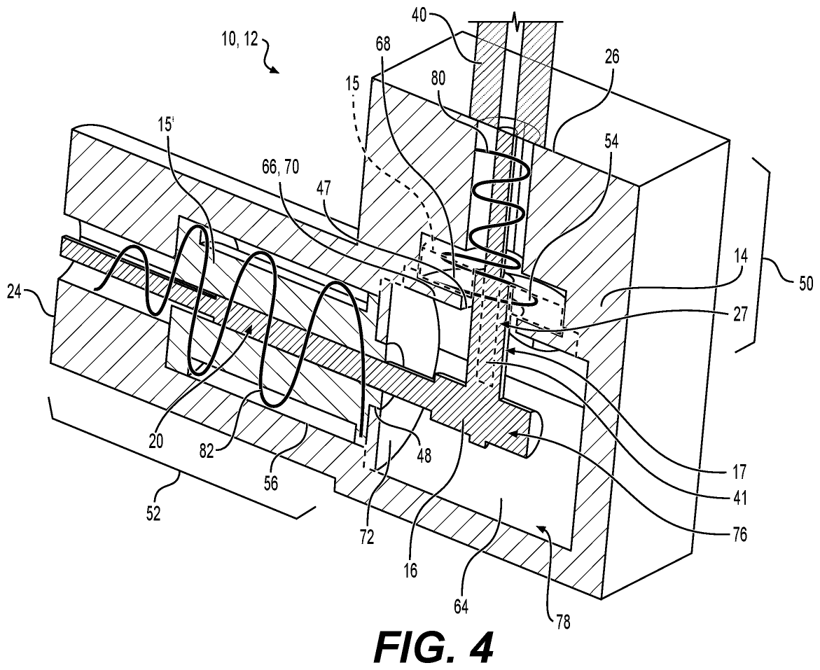

With respect to the angled coaxial cable adapter 12 of FIG. 4, the angled coaxial cable adapter includes a housing 14, a terminal pin 16, a first insulator 15, a second insulator 15′, a first signal blocking portion 72 and a second signal blocking portion 70. The first insulator 15 is configured to support a portion 17 of the terminal pin 16, which includes the conductor receiving portion 27, and the second insulator 15′ is configured to support the conductive pin portion 42 of the terminal pin 16.

As shown in FIG. 4, the first signal blocking portion 72 includes a first aperture 73 structurally configured to receive the first portion 17 of the terminal pin 16, and the second signal blocking portion 70 includes a second aperture 71 structurally configured to accommodate the conductive portion 20 of the terminal pin 16. It is understood that the first signal blocking portion 72 and the second signal blocking portion 70 may be separate components that are disposed in the first conductive portion receiving portion 54 and the second conductive portion receiving portion 56, respectively. Alternatively, the first signal blocking portion 72 and/or the second signal blocking portion 70 may be integral to the housing 14, that is, a single, monolithic piece of unitary construction. In any case, the first signal blocking portion 72 and/or the second signal blocking portion 70 has an inner diameter that is less that an inner diameter of the first conductive portion receiving portion 54 and the second conductive portion receiving portion 56, respectively, so as to provide a conductive barrier that is structurally configured to prevent, block, or limit the first and second RF signal waves 80, 82 from entering the third signal wave receiving portion 64 where the bend is disposed.

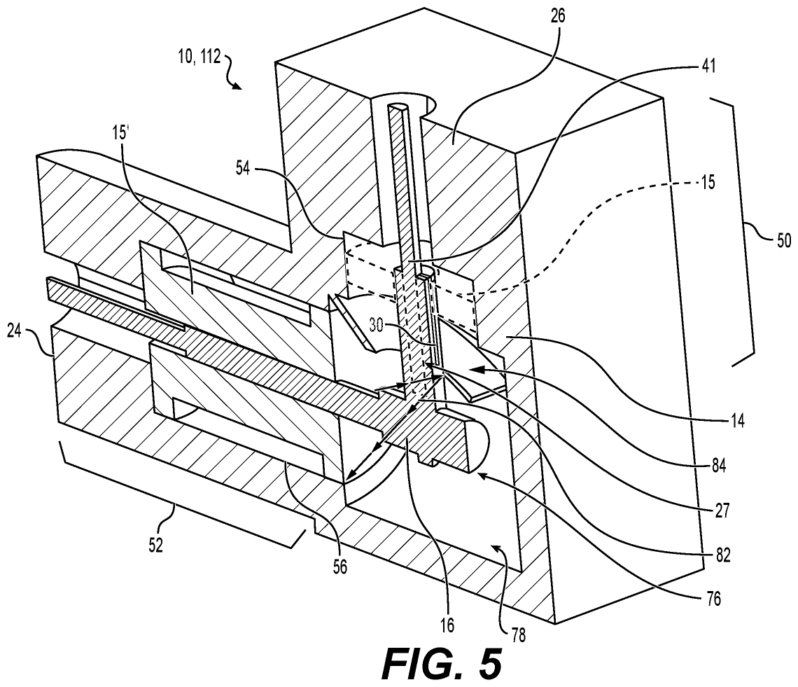

With respect to the angled coaxial adapters 12 shown in FIGS. 5 and 6, the angled coaxial cable adapter includes a housing 14 having a first portion 50, a second portion 52, the terminal pin 16, the first insulator 15, the second insulator 15′, and a signal wave blocking portion 23, for example, a wall, disposed at a middle portion 78 of the angled coaxial adapter 12. The terminal pin 16 is at least partially disposed in both the first conductive portion receiving portion 50 and the second conductive portion receiving portion 52. The first insulator 15 is structurally configured to be disposed in the first portion 50, and the second insulator 15′ is structurally configured to be disposed in the second portion 52 of the housing 14. The first portion 50 of the housing includes the first conductive portion receiving portion 54 and the second portion 52 of the housing includes the second conductive portion receiving portion 56. The first conductive portion receiving portion 54 is disposed at an angle relative to the second conductive portion receiving portion 56. The middle portion 78 of the angled coaxial adapter is the region where the first portion 50 meets the second portion 52. The housing of the adapter bends at the middle portion 78.

The exemplary adapters of FIGS. 5 and 6 provide a first signal wave receiving portion 60, a second signal wave receiving portion 62, and a third cavity 64. As a radio frequency (RF) signal passes through the adapter, the RF signal changes direction at the bend portion 76, for example, by ninety degrees. Thus, first RF signal waves 80 travel through the first signal wave receiving portion 60 in the first direction, and second RF signal waves travel through the second signal wave receiving portion 62 in the second direction 82. A signal wave blocking portion 84 is structurally configured to prevent, block, or limit the first RF signal waves 80 in the first signal receiving portion 60 from entering the third signal wave receiving portion 64. Similarly, the signal wave blocking portion 84 is structurally configured to prevent, block, or limit the second RF signal waves 82 in the second signal receiving portion 62 from entering the third signal wave receiving portion 64.

As illustrated, in some embodiments, the signal wave blocking portion 84 may not extend completely around the conductive members. In view of the wavelengths of the higher frequency RF signal waves, a signal wave blocking portion 84 that extends only part of the way, for example, about half way, around the conductive members may be effective to prevent, block, or limit the first and second RF signal waves 80, 82 from entering the third signal wave receiving portion 64.

As a result, the adapter 12 can operate at higher frequencies, such as 1.3-3.0 GHz, or even higher frequencies, as compared to existing adapters that operate at frequencies from 0-1.2 GHz. This is an emerging requirement for current and future RF connectors. If cross-sections are taken perpendicular to the line of signal travel path, the cross-sections remain considerably similar around the ninety-degree bend through the cavity. The electrical signal can traverse that distance with minimum radio frequency interference. Accordingly, the first signal blocking portion 72 and the second signal blocking portion 66 minimize radio frequency interference caused by the change in direction of a signal through the conductive portion 16.

While multiple exemplary, non-limiting embodiments have been presented in the foregoing detailed description, it should be appreciated that a vast number of variations exist. It should also be appreciated that the exemplary embodiment or exemplary embodiments are only examples, and are not intended to limit the scope, applicability, or configuration of the disclosure in any way. Rather, the foregoing detailed description will provide those skilled in the art with a convenient road map for implementing the exemplary embodiment or exemplary embodiments. It should be understood that various changes can be made in the function and arrangement of elements without departing from the scope of the disclosure as set forth in the appended claims and the legal equivalents thereof.

What is claimed is:

1. An angled coaxial cable adapter structurally configured to provide an enhanced radio frequency (RF) signal, comprising:
a housing portion structurally configured to include a first RF signal wave receiving portion, a second RF signal wave receiving portion, and a third RF signal wave receiving portion disposed between the first RF signal wave receiving portion and the second RF signal wave receiving portion;
a conductive portion structurally configured to pass an RF signal through the first RF signal wave receiving portion, the second RF signal wave receiving portion, and the third RF signal wave receiving portion of the housing;
a first insulating portion structurally configured to hold a first portion of the conductive element in the first RF signal wave receiving portion of the housing;
a second insulating portion structurally configured to hold a second portion of the conductive element in the second RF signal wave receiving portion of the housing;
an RF signal wave blocking portion structurally configured to block an RF signal wave in the first RF signal wave receiving portion of the housing or an RF signal wave in the second RF signal wave receiving portion of the housing from entering the third RF signal wave receiving portion of the housing;
wherein the first RF signal wave receiving portion is structurally configured to be disposed at an angle relative to the second RF signal wave receiving portion;
wherein the conductive portion includes a first conductive portion at least partially disposed in the first RF signal wave receiving portion of the housing and a second conductive portion at least partially disposed in the second RF signal wave receiving portion of the housing;
wherein the conductive portion is structurally configured to include a bend at the third RF signal wave receiving portion of the housing;
wherein the RF signal wave blocking portion includes a first RF signal wave blocking portion between the first RF signal wave receiving portion and the third RF receiving portion that is structurally configured to block a first RF signal wave in the first RF signal wave receiving portion from entering the third RF signal wave receiving portion and a second RF signal wave blocking portion between the second RF signal wave receiving portion and the third RF receiving portion that is structurally configured to block a second RF signal wave in the second RF signal wave receiving portion from entering the third RF signal wave receiving portion; and
wherein the first RF signal wave blocking portion and the second RF signal wave blocking portion are structurally configured to block the first RF signal wave and the second RF signal wave from interfering with one another so as to reduce potential noise when a signal changes direction at the bend of the conductive element such that the adapter can provide an enhanced RF signal at frequencies of 1.3 GHz and greater.

2. The angled coaxial cable adapter of claim 1, wherein the first RF signal wave blocking portion and the second RF signal wave blocking portion each comprise a conductive material.

3. The angled coaxial cable adapter of claim 1, wherein the first RF signal wave receiving portion is structurally configured to be disposed at a ninety degree angle relative to the second RF signal wave receiving portion.

4. The angled coaxial cable adapter of claim 1, wherein the housing portion includes a first portion that is structurally configured to define the first RF signal wave receiving portion and a second portion that is structurally configured to define the second RF signal wave receiving portion.

5. The angled coaxial cable adapter of claim 4, wherein the first portion of the housing portion is structurally configured to be electrically coupled with an interface port and the second portion of the housing portion is structurally configured to be electrically coupled with a coaxial cable connector.

6. The angled coaxial cable adapter of claim 1, wherein the first RF signal wave blocking portion and the second RF signal wave blocking portion are structurally configured to block the first RF signal wave and the second RF signal wave from interfering with one another so as to reduce potential noise when a signal changes direction at the bend of the conductive element such that the adapter can provide an enhanced RF signal at frequencies of 3 GHz and greater.

7. An angled coaxial cable adapter structurally configured to provide an enhanced radio frequency (RF) signal, comprising:
a housing portion structurally configured to include a first RF signal wave receiving portion and a second RF signal wave receiving portion;
a conductive portion structurally configured to pass an RF signal through the first RF signal wave receiving portion, the second RF signal wave receiving portion, and the third RF signal wave receiving portion of the housing;
an RF signal wave blocking portion structurally configured to block an RF signal wave in the first RF signal wave receiving portion of the housing or an RF signal wave in the second RF signal wave receiving portion of the housing from entering the third RF signal wave receiving portion of the housing;
wherein the first RF signal wave receiving portion is configured to be disposed at an angle relative to the second RF signal wave receiving portion;
wherein the conductive portion is structurally configured to include a bend at the third RF signal wave receiving portion of the housing; and
wherein the RF signal wave blocking portion is structurally configured to block the first RF signal wave and the second RF signal wave from interfering with one another so as to reduce potential noise when a signal changes direction at the bend of the conductive element such that the adapter can provide an enhanced RF signal at frequencies of 1.3 GHz and greater.

8. The angled coaxial cable adapter of claim 7, further comprising a first insulating portion structurally configured to hold a first portion of the conductive element in the first RF signal wave receiving portion of the housing; and
a second insulating portion structurally configured to hold a second portion of the conductive element in the second RF signal wave receiving portion of the housing.

9. The angled coaxial cable adapter of claim 7, wherein the conductive portion includes a first conductive portion at least partially disposed in the first RF signal wave receiving portion of the housing and a second conductive portion at least partially disposed in the second RF signal wave receiving portion of the housing; and
wherein the conductive portion is structurally configured to include a bend at the third RF signal wave receiving portion of the housing;

10. The angled coaxial cable adapter of claim 7, wherein the RF signal wave blocking portion includes a first RF signal wave blocking portion between the first RF signal wave receiving portion and the third RF receiving portion that is structurally configured to block a first RF signal wave in the first RF signal wave receiving portion from entering the third RF signal wave receiving portion and a second RF signal wave blocking portion between the second RF signal wave receiving portion and the third RF receiving portion that is structurally configured to block a second RF signal wave in the second RF signal wave receiving portion from entering the third RF signal wave receiving portion.

11. The angled coaxial cable adapter of claim 10, wherein the first RF signal wave blocking portion and the second RF signal wave blocking portion each comprise a conductive material.

12. The angled coaxial cable adapter of claim 10, wherein the first RF signal wave receiving portion is structurally configured to be disposed at a ninety degree angle relative to the second RF signal wave receiving portion.

13. The angled coaxial cable adapter of claim 10, wherein the housing portion includes a first portion that is structurally configured to define the first RF signal wave receiving portion and a second portion that is structurally configured to define the second RF signal wave receiving portion.

14. The angled coaxial cable adapter of claim 7, wherein the first portion of the housing portion is structurally configured to be electrically coupled with an interface port and the second portion of the housing portion is structurally configured to be electrically coupled with a coaxial cable connector.

15. The angled coaxial cable adapter of claim 7, wherein the first RF signal wave blocking portion and the second RF signal wave blocking portion are structurally configured to block the first RF signal wave and the second RF signal wave from interfering with one another so as to reduce potential noise when a signal changes direction at the bend of the conductive element such that the adapter can provide an enhanced RF signal at 3 GHz and greater.

16. An angled coaxial cable adapter structurally configured to provide an enhanced radio frequency (RF) signal, comprising:
a housing portion structurally configured to include a first RF signal wave receiving portion and a second RF signal wave receiving portion;
a conductive portion structurally configured to pass an RF signal through the first RF signal wave receiving portion and the second RF signal wave receiving portion;
wherein the first RF signal wave receiving portion is configured to be disposed at an angle relative to the second RF signal wave receiving portion;
wherein the conductive portion is structurally configured to include a bend; and
wherein the RF signal wave blocking portion is structurally configured to block the first RF signal wave and the second RF signal wave from interfering with one another so as to reduce potential noise when a signal changes direction at the bend of the conductive element such that the adapter can provide an enhanced RF signal.

17. The angled coaxial cable adapter of claim 16, further comprising a first insulating portion structurally configured to hold a first portion of the conductive element in the first RF signal wave receiving portion of the housing; and
a second insulating portion structurally configured to hold a second portion of the conductive element in the second RF signal wave receiving portion of the housing.

18. The angled coaxial cable adapter of claim 16, wherein the conductive portion includes a first conductive portion at least partially disposed in the first RF signal wave receiving portion of the housing and a second conductive portion at least partially disposed in the second RF signal wave receiving portion of the housing.

19. The angled coaxial cable adapter of claim 16, further comprising a third RF signal wave receiving portion disposed between the first RF signal wave receiving portion and the second RF signal wave receiving portion.

20. The angled coaxial cable adapter of claim 19, wherein the RF signal wave blocking portion includes a first RF signal wave blocking portion between the first RF signal wave receiving portion and the third RF receiving portion that is structurally configured to block a first RF signal wave in the first RF signal wave receiving portion from entering the third RF signal wave receiving portion and a second RF signal wave blocking portion between the second RF signal wave receiving portion and the third RF receiving portion that is structurally configured to block a second RF signal wave in the second RF signal wave receiving portion from entering the third RF signal wave receiving portion.

21. The angled coaxial cable adapter of claim 20, wherein the first RF signal wave blocking portion and the second RF signal wave blocking portion each comprise a conductive material.

22. The angled coaxial cable adapter of claim 16, wherein the first RF signal wave receiving portion is structurally configured to be disposed at a ninety degree angle relative to the second RF signal wave receiving portion.

23. The angled coaxial cable adapter of claim 16, wherein the housing portion includes a first portion that is structurally configured to define the first RF signal wave receiving portion and a second portion that is structurally configured to define the second RF signal wave receiving portion.

24. The angled coaxial cable adapter of claim 16, wherein a first portion of the housing portion is structurally configured to be electrically coupled with an interface port and a second portion of the housing portion is structurally configured to be electrically coupled with a coaxial cable connector.

25. The angled coaxial cable adapter of claim 16, wherein the RF signal wave blocking portion comprises a conductive material.

26. The angled coaxial cable adapter of claim 16, wherein the RF signal wave blocking portion is structurally configured to block the first RF signal wave and the second RF signal wave from interfering with one another so as to reduce potential noise when a signal changes direction at the bend of the conductive element such that the adapter can provide an enhanced RF signal at frequencies of 3 GHz and greater.

27. The angled coaxial cable adapter of claim 16, wherein the RF signal wave blocking portion is structurally configured to block the first RF signal wave and the second RF signal wave from interfering with one another so as to reduce potential noise when a signal changes direction at the bend of the conductive element such that the adapter can provide an enhanced RF signal at frequencies of 1.3 GHz and greater.
